(19) United States
(12) Patent Application Publication
(10) Pub. No.: US 2004/0239628 A1
(43) Pub. Date: Dec. 2, 2004

(54) User interactive cursor control in a computer controlled display system by a mouse or like device with a housing molded to the contours of the hand palm of one specific user

(75) Inventor: Timothy Alan Dietz, Austin, TX (US)

Correspondence Address: International Business Machines Corporation, Intellectual Property Law Department, Internal Zip 4054, 11400 Burnet Road, Austin, TX, 78758, US

(73) Assignee: International Business Machines Corporation, Armonk, NY

(21) Appl. No.: 10/448,271

(22) Filed: May 29, 2003

(51) Int. Cl. G09G 5/08

(52) U.S. Cl. 345/163

(57) ABSTRACT

A user activated cursor control device, such as a trackball or mouse, that is movable in the four orthogonal directions. The control device is connected to the computer and includes means for converting the user activated orthogonal movements into cursor movements in said four directions. A manually operated image control device, such as a mouse in which the housing portion in contact with the palm of the user's hand is contoured or molded to the palm of the hand of each specific user. Only the upper portion of the mouse housing that contacts the user hand palm need be individually molded; the lower portion of the housing, including the entire supported conventional mechanical image control apparatus would remain in tact.

### TECHNICAL FIELD

The present invention relates to user interactive computer supported display technology and particularly to such user interactive systems and methods that provide computer users with a computer interface environment that is easy to use and less fatiguing; particularly with respect to controlling screen image, e.g. cursor movements.

### BACKGROUND OF RELATED ART

The past decade has been marked by a technological revolution driven by the convergence of the data processing industry with the consumer electronics industry. This advance has been even further accelerated by the extensive consumer and business involvement in the Internet over the past several years. As a result of these changes, it seems as if virtually all aspects of human endeavor in the industrialized world require human-computer interfaces. Because of these profound changes, there is a need to make computer directed activities accessible to a substantial portion of the world's population which, up to a few years ago, was computer-illiterate or, at best, computer indifferent.

Despite all of the great changes that have been made in the computer industry, the screen cursor controlled manually by the user still remains the primary human-computer interface. The user still commands the computer primarily through manual pointing devices such as mice or trackballs that control the on-screen cursor movements. It must be noted that the principles involved in such pointing devices developed a generation ago when most of the people involved in interfaces to computers were computer professionals who were willing to invest great amounts of time in developing computer skills. It is very possible that had computers originally been the mass consumer, business and industry implements that they are today, user interfaces that were much easier and required less skill to use would have been sought originally and developed. Nonetheless, the manually controlled cursor movement devices are our primary access today for cursor control.

In addition, the computer has been found to be most effective as a work saving device in situations requiring a user to interface with the display for a limited number of repetitive functions, but often for a long time period. Such repetitive functions can produce hand fatigue that can lead to stress related injuries. Also, in the work place, these repetitive functions may be performed by people of very limited computer interface skills and dexterity. Since such users or operators would have limited mouse skills, it would be advantageous to be able to optimize the effectiveness of user manual orthogonal movements in performing the repetitive functions.

Cursor control devices, such as the mouse, translate relatively precise orthogonal manual movements into precise cursor movements on the display screen. Users with poor hand-eye coordination due to poor eyesight, physical impairment, feebleness or other dexterity problems find the computer mouse to be even more stressful, frustrating and injury causing.

The present invention is directed to making mouse, trackball and the like cursor control devices more user friendly, effective, less fatiguing and less injury inducing.

### SUMMARY OF THE PRESENT INVENTION

The present invention is directed to interactive computer controlled display systems and particularly to systems for controlling image, e.g. cursor movement on the display screen. There is provided a user activated cursor control device, such as a trackball or mouse, that is movable in the four orthogonal directions. The control device is connected to the computer that includes means for converting the user activated orthogonal movements into cursor movements in said four directions. The key to the present invention is in the provision of a manually operated image control device, such as a mouse, in which the housing portion in contact with the palm of the user's hand is contoured or molded to the palm of the hand of each specific user. It should be noted that as used herein, the palm of the hand is the inner surface of the hand, below the wrist, including the inner surfaces of the fingers.

In a marketplace where a generic mouse nay be purchased for as little as twenty dollars, the question may be raised as to the economic feasibility of such a molded mouse expedient that could triple the cost of the device. However, when it is considered that a mouse or like control device, or at least its housing, could be used for years, then, any diminution of user injury or fatigue over such long period would justify the increased cost.

In accordance with the present invention, only the upper portion of the mouse housing that contacts the user's hand palm need be individually molded; the lower portion of the housing, including the entire supported conventional mechanical image control apparatus would remain intact. However, even this increased cost could be lessened with a specific embodiment offered by the present invention wherein the mouse or like device would be provided in a package or kit containing a standard lower housing portion supporting a control system for controlling said image, e.g. cursor movement. In addition, there would be included a blank stock element formed of a hardenable material and having a perimeter adapted to engage said lower housing portion. Then the user would be instructed to impress the palm of the user's hand, including fingers, into said blank stock element to contour the element to the contours of the palm and the contoured element would be hardened to provide an upper housing portion molded to the specific contours of the user's hand palm including the inner surfaces of the user's fingers. This molded upper housing portion could then be engaged with the intact lower housing portion to thereby enclose said control system.

During any molding or impression step with respect to palm contours, an appropriate set of apertures in said blank stock element would be maintained to permit said user to access a set of buttons in the control system respectively corresponding to said apertures in the completed upper housing portion.

In order to insure that any blank stock or member to be molded is engageable with the intact lower housing, there should be formed and maintained during molding or impression, a rigid non-moldable rim in said blank stock element adapted for said engagement with said lower housing portion.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIGS. 1 through 7 are steps in one process for forming a user-specific interactive display manual control device molded to the contours of the user's hand.

### DETAILED DESCRIPTION OF THE PREFERRED EMBODIMENT

The present invention involves the molding of the housing of the manual control device, e.g. computer mouse controlling on display screen movement to the contours of the specific user's hand palm to diminish fatigue and possible stress injury resulting from continuous and repetitive use over long time periods. As will be hereinafter described in greater detail, the only portion of the mouse housing that needs to be individually molded or contoured is the upper portion of the housing that contacts the palm of the user's hand. In the mouse embodiment, for example, the present invention is not limited to molding the upper mouse housing by any particular molding or contouring process as long as the process molds the upper portion to the contours of the user's palm. A conventional molding process may be used wherein an impression is taken of the user's palm, including the inner surfaces of the user's fingers in a suitable medium, e.g. clay from which a, mold for the upper housing portion is cast. This mold will, of course, contain forms for appropriate apertures in the upper housing through which buttons in the mouse control apparatus may be accessed in the completed housing. The upper mouse housing portion containing apertures and contoured to the palm of the hand of the user is then cast of a suitable plastic material in this mold. This upper housing portion is structured so as to be engageable with the lower housing portion in which the cursor moving apparatus is mounted and supported to thereby complete the user contoured mouse.

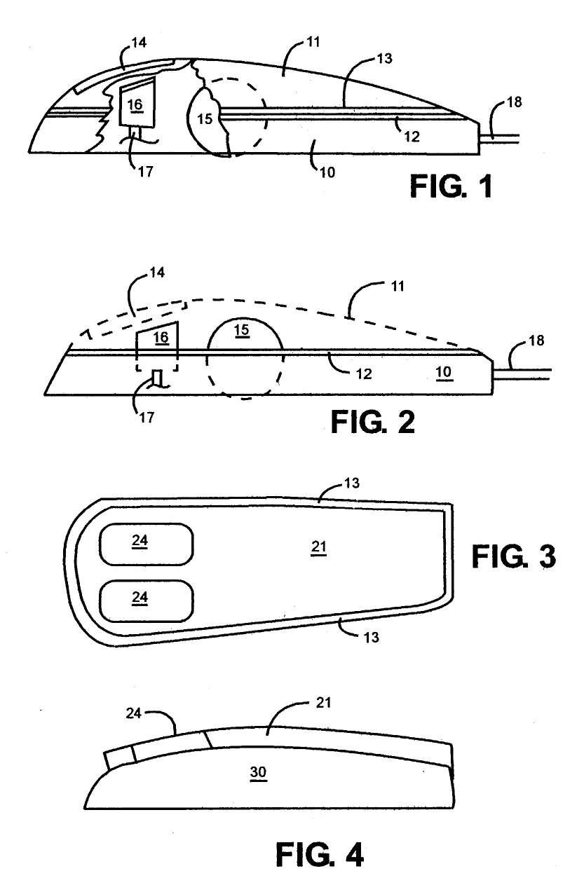

As mentioned hereinabove, such a molding process though costly on an individual basis may be justified for mice used by certain operators under certain operating conditions. On the other hand, for situations where the higher specific contouring cost may not be justifiable, the following alternative process for contouring will be described with respect to FIGS. 1 through 7.

With respect to FIG. 1, a generalized diagram of a conventional mouse structure is shown with a portion broken away to reveal a representational portion of the cursor control apparatus. Lower portion of the mouse housing 10 supports the cursor control apparatus as represented by mouse ball 15, control buttons 16 and button connector 17. Upper housing portion 11 has apertures 14 through which buttons may be accessed. Upper housing 11 engages lower housing 10 via interlocking rim 13 that engages and locks with rim 12 in lower housing portion 10 to thereby enclose the mouse cursor control apparatus. Connector 18 connects the mouse to the computer display.

In the process for contouring the upper housing portion to the hand of the user in accordance with the present invention, the lower housing portion 10 and the supported control apparatus remains unchanged and intact as shown in FIG. 2, with removed upper housing portion shown in dashed lines 11. There will now be formed an upper housing portion from a contourable blank form 21 shown in FIG. 3. Such a form could be included in a mouse package or kit. Since the lower portion 10 is unchanged, rim 13 would also be rigid and unchangeable so that it could subsequently normally engage rim 12 of lower housing portion 10, as will hereinafter be described. Form 21 could be formed of any currently available pliable or contourable soft material that may be hardened to a rigid state after contouring through air-dry or the application of heat. Apertures 24 may be precut in form 21 so as to coincide with control apparatus buttons 16. Form 21 could be made of commercially available CraftCote™, which is a gypsum and cement mixture mixed with a bonding catalyst responsive to the addition of water.

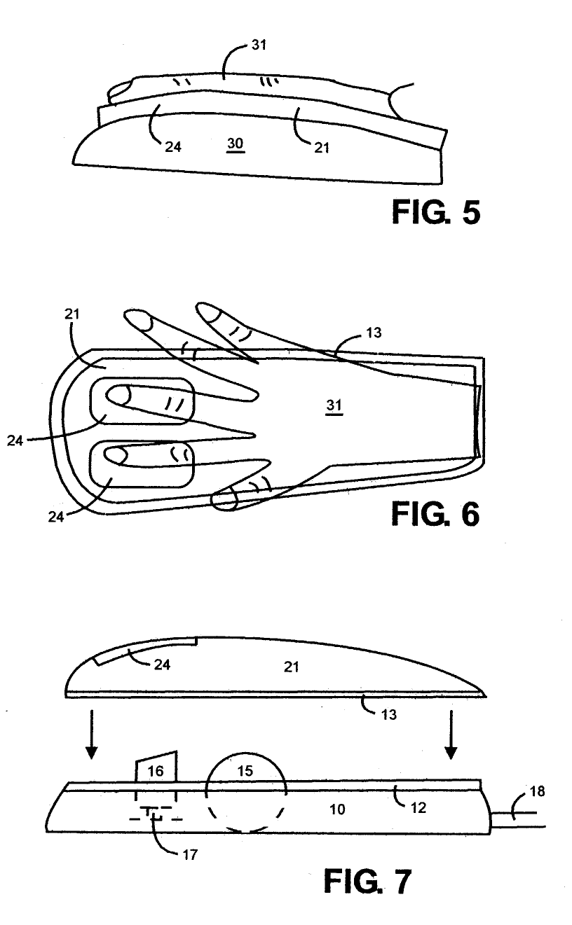

An alternative material that may be used for form 21 is an air-hardenable epoxy resin. With such epoxy resins, it is the practice to store the resin base material separate its catalyst which is stored separately in its own pliable binder. If such an epoxy resin were to be used, a layer containing the epoxy resin in an appropriate binder could be provided in a mouse package separate from the catalyst. A variety of such epoxy resin layers stored separate from catalysts prior to use are commercially available. An example of such an air hardenable epoxy resin set is the Milliput™ product line. Then, prior to use, the epoxy resin and its catalyst would be mixed and kneaded together and the soft layer evenly spread within defining rim 13. Then a pair of dies would be used to cut out apertures 24, the formation process could then proceed to the step of FIG. 4. Then, irrespective of how blank 21 was formed, the form 21 in FIG. 4 could be placed on a pliable releasable member 30 and the catalyst activated by the application of water, after which the user's hand 31, palm down, is impressed on form 21 as shown in FIGS. 5 and 6 to contour form 21 into an upper portion of the mouse housing. The housing is suitably air or heat dried to provide the contoured completed upper housing portion 21, FIG. 7, is then pressed into engagement with lower portion 10 that has remained intact via unaltered rim 13 engaging rim 12 in any appropriate interlocking relationship.

While the invention has been illustrated by means of a diagrammatic construction of a mouse contoured to the palm of the specific user's hand, it will be understood that the invention is applicable to the molding or contouring of any manual control device for implementing movement of images on a computer display screen, e.g. a game pad or even an appropriate trackball.

Although certain preferred embodiments have been shown and described, it will be understood that many changes and modifications may be made therein without departing from the scope and intent of the appended claims.

What is claimed is:

1. In a computer controlled user interactive display having a graphical user interface, a user-specific interactive manual control device connected to said computer for controlling image movement on the display comprising:
a lower housing portion supporting control apparatus for controlling said image movement; and
an upper housing portion molded to the specific contours of the hand palm of said user and adapted to engage said lower housing portion to thereby enclose said control apparatus.

2. The user-specific interactive manual control device of claim 1 wherein said upper housing portion includes a set of apertures permitting said user to access a set of buttons in said control apparatus respectively corresponding to said apertures.

3. The user-specific interactive manual control device of claim 2 wherein said manual control device is a computer mouse.

4. The user-specific interactive manual control device of claim 3 wherein said controlled image is a cursor on said display.

5. The user-specific interactive manual control device of claim 3 wherein said upper housing portion further includes a rigid non-moldable rim adapted for said engagement with said lower housing portion.

6. The user-specific interactive manual control device of claim 2 wherein said manual control device is a computer game pad.

7. A method of making a user contoured interactive manual control device connected to a computer controlled user interactive display having a graphical user interface for controlling image movement on the display comprising:
providing a standard lower housing portion supporting a control system for controlling said image movement;
molding an upper housing portion molded to the specific contours of the hand palm of said user; and
engaging said molded upper housing portion with said lower housing portion to thereby enclose said control system.

8. The method of making the user contoured interactive manual control device of claim 7 further including the step of maintaining a set of apertures in said molded upper housing portion to permit said user to access a set of buttons in said control system respectively corresponding to said apertures.

9. The method of making the user contoured interactive manual control device of claim 8 wherein said manual control device is a computer mouse.

10. The method of making the user contoured interactive manual control device of claim 9 wherein said controlled image is a cursor on said display.

11. The method of making the user contoured interactive manual control device of claim 10 further including the step of forming a rigid non-moldable rim in said upper housing portion adapted for said engagement with said lower housing portion prior to said molding step.

12. The method of making the user contoured interactive manual control device of claim 8 wherein said manual control device is a computer game pad.

13. A method of making a user contoured interactive manual control device connected to a computer controlled user interactive display having a graphical user interface for controlling image movement on the display comprising:
providing a standard lower housing portion supporting a control system for controlling said image movement;
providing a blank stock element formed of a hardenable material and having a perimeter adapted to engage said lower housing portion;
impressing the palm of the user's hand into said blank stock element to contour the element to the contours of said palm;
hardening said contoured element to provide an upper housing portion molded to the specific contours of the user's hand palm; and
engaging said molded upper housing portion with said lower housing portion to thereby enclose said control system.

14. The method of making the user contoured interactive manual control device of claim 13 further including the step of maintaining a set of apertures in said blank stock element to permit said user to access a set of buttons in said control system respectively corresponding to said apertures in the completed upper housing portion.

15. The method of making the user contoured interactive manual control device of claim 14 wherein said manual control device is a computer mouse.

16. The method of making the user contoured interactive manual control device of claim 14 further including the step of forming a rigid non-moldable rim in said blank stock element adapted for said engagement with said lower housing portion prior to said step of impressing the palm of said user's hand.
